(19) United States
(12) Patent Application Publication
(10) Pub. No.: US 2024/0107156 A1
(43) Pub. Date: Mar. 28, 2024

(54) Socket Camera APP

(71) Applicant: Kevin Vernon, Hamilton (CA)

(72) Inventor: Kevin Vernon, Hamilton (CA)

(21) Appl. No.: 17/803,662

(22) Filed: Sep. 28, 2022

(51) Int. Cl. H04N 5/232; G02B 27/00; G02B 27/01; G06T 19/00; H04W 4/00; H04W 12/50

(52) U.S. Cl. CPC H04N 5/232061; G02B 27/0093; G02B 27/0101; G02B 27/017; G02B 27/0179; G06T 19/006; H04N 5/23299; H04W 4/00; H04W 12/50; G02B 2027/014; G02B 2027/0187

(57) ABSTRACT

The Socket Camera APP is the software application that will be used to communicate and provide data and unique binary instructions to the Socket Camera hardware device. Primarily it will manifest coded data namely the instructions for the Socket Camera to convert and stitch the images it captures to be rendered for viewing in virtual reality in a VR headset. It will send direct code to the Socket Camera to enable pan, tilt and other manoeuvres by means of a VR headset system

This APP will also configure coded data that will enable a Wi-Fi or Bluetooth speakers(s) (namely the Socket Camera) to pair multiple speakers by means of UHF or RF signals to achieve surround sound audio with ratios such as 2.1, 4.1, 5.1 and 7.1 or which ever ratio selected by the user.

### FIELD OF INVENTION

The present invention details a computing software application that will facilitate the pairing of a camera (namely the Socket Camera) to enable it with Virtual reality functions with hands free or assisted hardware camera control. This invention also details how this software will pair and enable any WiFi or Bluetooth speaker to become integrated as a surround sound speaker.

### BACKGROUND OF THE INVENTION

As technology advances so does the need for innovation. Advancements in camera technology has always been a leading trend. From better resolution to where and how cameras can be used. Also, for cameras to be less reliant on being hard wired. The Socket Camera APP is the embodiment of software that promotes the advancement of camera technology in the home surveillance industry. This software will utilize virtual reality as a method of home monitoring namely performed by the Socket Camera. This software will allow the user to don a VR headset system and monitor property locally and remotely. While wearing a VR headset the user will be able to control the movements of the Socket Camera by moving their head left, right, up or down and the Socket Camera APP will send manifested coded data received by the data collected from the sensors that create the virtual reality effect to the Socket Camera device to perform the functions of panning and tilting. This software will also facilitate the pairing of a VR headset system so that while the user is donning the VR headset and using the VR controllers the user will be able to interface and control the movements of the camera by means of the VR controller joysticks. As the Socket Camera is a multi function device and has the implementation of a speaker system. The Socket Camera APP or software has made improvements in the area of a multi speaker sound system. This software will facilitate the pairing of any WiFi, Bluetooth, RP or UHF speaker(s) allowing the user to achieve 2.1, 4.1, 5.1, 7.1 or which ever ratio elected of surround sound. The consumer will no longer be limited as to the obligation of speakers that will be provided when purchasing a surround sound system. The consumer will be able to mix and match any RF or UHF speaker indoor or outdoors.

### BRIEF SUMMARY OF THE INVENTION

This software will facilitate the pairing of any WiFi, Bluetooth, RF or UHF speaker for the purpose of creating 2.1, 4.1, 5.1, 7.1 or which ever ratio elected of surround sound that will be configured and controlled by a source device in which the software has been downloaded to.

This software will also create coded data so that the Socket Camera light bulb camera device can be utilized as a true single lens real time virtual reality camera hands free by donning a VR headset alone or by using the VR headset joysticks to interface and manoeuvre the camera.

### BRIEF DESCRIPTION OF THE DRAWINGS

Some embodiments of the presented invention are illustrated as an example and are not limited by the figures of the accompanying drawings.

Diagram 1 Is a representation of the Socket Camera APP software and how it will execute the function of allowing a source device with enabled virtual reality to remotely control the functions of the Socket Camera.

FIG. 1 is the source device which the software had been downloaded too.

FIG. 2 is a virtual reality headset and virtual reality controller system.

FIG. 3 is a local network modem.

FIG. 3a is a remote network modem.

FIG. 4 is an ISP internet network.

FIG. 5 audio/video surveillance device that is equipped with lighting and mini speakers.

Diagram 2 is a representation of the Socket Camera APP software and how it will be paired with WiFi or Bluetooth speakers for the purpose of achieving surround sound.

FIG. 6 is the source device in which the software had been downloaded too.

FIG. 7 are front speakers.

FIG. 8 are middle speakers,

FIG. 9 are rear speakers.

FIG. 10 is the modem/router.

Diagram 3 is a representation of the software and how WiFi direct or Bluetooth connectivity would be implemented (with suitable speakers).

FIG. 11 is the source device in which the software had been downloaded too.

FIG. 12 is a centre front speaker.

FIG. 13 are front speakers.

FIG. 14 are rear speakers.

### DETAILED DESCRIPTION OF THE INVENTION

Diagram 1. Is a representation of the Socket Camera APP software and how it will execute the function of allowing a source device such as a smart phone, computer, laptop, tablet, game console or any technical device that can support application software to enable a VR headset system to remotely control the functions and features of the Socket Camera. The Socket Camera APP will facilitate the pairing of a CAMERA namely the Socket Camera to a VR HEADSET and VR Controller SYSTEM.

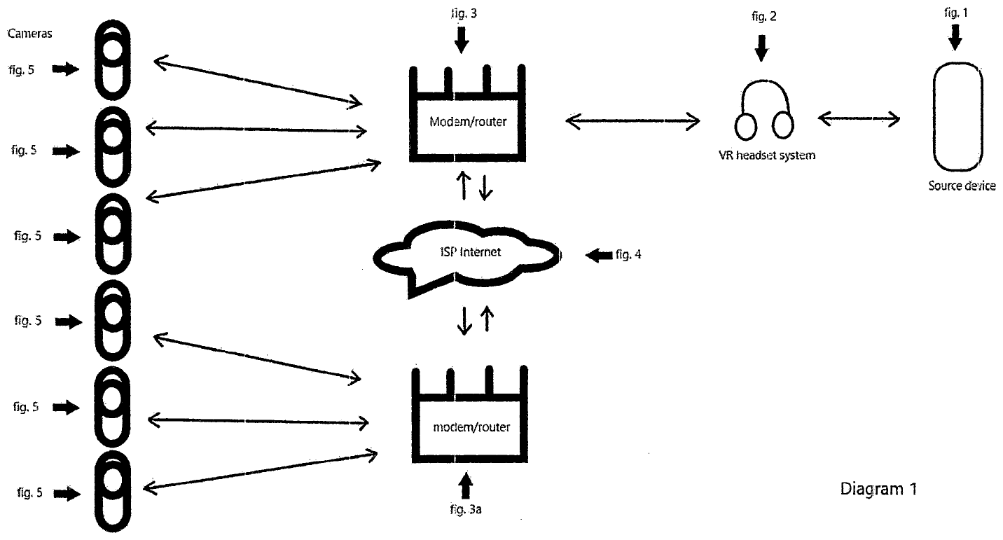

FIG. 1. As indicated in Diagram 1 is the source device. The source device would be any such device as stated in the diagram description of diagram 1. The source device is the CPU and computing interface that the Socket Camera APP has been downloaded to. On this device the user will be able to view captured footage and perform all of the functions and features of the Socket Camera. This App will provide features such as a music player, (for recorded or streaming music), facial recognition, cloud connectivity, temperature and hygrometer readings. Capture modes such as 360 degree VR capture stitch and render, infra red, night vision, sepia tone, B & W, radiance adjustments and low light capture. This source device will provide the interface for the VR headset and controller system to interact and control the functions and features of the Socket Camera.

FIG. 2. As indicated in Diagram 1 is a VR headset and VR controller system. This VR headset system would be such as an Oculus rift or any VR headset that is worn on the head and over the eyes accompanied with a hand held controller(s) for the purpose of viewing moving or still images in virtual reality. This APP will also configure coded data that will enable a VR headset to send direct code to the Socket Camera to manoeuvre (pan or tilt) according to the directions that the user is turning their head while donning the VR headset. The sensors in the VR headset that create the virtual reality effect can detect when the user turns their head left, right, up or down and will relay the coding data to the Socket camera to perform the functions of panning and tilting in real time. This APP will facilitate utilizing a hand held device, joystick or remote control device. One will be capable of using the hand held joystick of a VR system to control the Socket Camera to perform functions like pan, tilt, zoom and make selections that are available in the menu of the Socket Camera while wearing a VR headset to be viewed in VR in real time in the VR headset.

FIG. 3. As indicated in Diagram 1 is the local network modem/router. This is the WiFi network that the Socket Camera APP will utilize to distribute and receive binary data instructions and enable all the functions and features of the Socket Camera APP to as many Socket Cameras that are paired on this network. This local network DOES NOT require to be connected to the Internet to perform its functions. The source device as defined in FIG. 1 can communicate with any hardware (camera) or peripheral (VR system) by means of Wi-fi signals transmitted by way of the local network modem/router. If the local network modem (FIG. 3) is required to transmit data to a remotely located modem it must establish a connection by means of connecting to the internet.

FIG. 3a. As indicated in Diagram 1 is the remote location modem/router. In order for this modem to communicate with the source device stated in FIG. 1. There must be an ISP Internet connection established. Once the FIG. 3a modem establishes a connection with the internet it can communicate with the FIG. 3 modem and execute any commands issued from the source device stated in FIG. 1.

FIG. 4. As indicated in Diagram 1 is an ISP internet network.

FIG. 5. As indicated in Diagram 1 is the Socket Camera. The Socket Camera is an audio/video surveillance device that is equipped with lighting and mini speakers. This is the primary hardware device for the Socket Camera APP.

Diagram 2. Is a representation of the Socket Camera APP software and how it will enable light bulb speakers, mini speakers or any WiFi or Bluetooth speakers namely that of the Socket Camera to pair and assign each unit containing speakers as surround sound speakers for your TV(s), game console, computer, laptop, tablet or personal device. Each unit containing speakers could be assigned as left, right, centre, middle, front or rear speakers allowing the user to achieve 2.1, 4.1, 5.1, 7.1 or which ever ratio elected of surround sound.

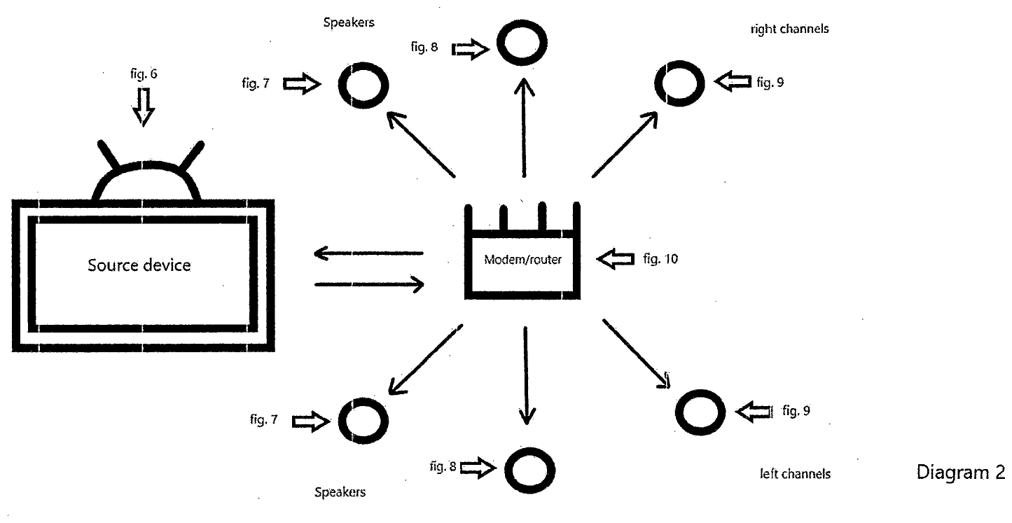

FIG. 6. As indicated in Diagram 2 is the source device such as a smart phone, computer, laptop, tablet, game console, smart TV or any technical device that can support application software. The source device is the CPU and computing interface that the Socket Camera APP has been downloaded to. The APP on the source device will configure and pair speakers and surround sound ratio selected by the user and send the data to a modem/router which will transmit audio to the selected speakers that are on the network. This diagram can be interpreted as 6.1 surround sound. If the source device indicated in FIG. 6 is equipped with suitable speakers it too can be assigned as a paired speaker to be executed in the surround sound selection making this diagram a representation of 7.1 surround sound.

FIG. 7. As indicated in Diagram 2 are speakers that have been assigned as front speakers for surround sound. One left channel and one right channel.

FIG. 8. As indicated in Diagram 2 are speakers that have been assigned as middle speakers for surround sound. One left channel and one right channel.

FIG. 9. As indicated in Diagram 2 are speakers that have been assigned as rear speakers for surround sound. One left channel and one right channel.

FIG. 10. As indicated in Diagram 2 is the modem/router. This modem/router will receive the data from the source device indicated as FIG. 6 and distribute the information to the selected paired speakers on the WiFi network. This is a local network and DOES NOT require an internet connection to be operational.

Diagram 3. Is a representation of the Socket Camera APP software and how it will enable light bulb speakers, mini speakers or any WiFi or Bluetooth speaker namely that of the Socket Camera to pair and assign each unit containing speakers as surround sound speakers for your Smart phone, game console, computer, laptop, tablet or personal device. Each unit containing speakers could be assigned as left, right, centre, middle, front or rear speakers allowing the user to achieve 2.1, 4.1, 5.1, 7.1 or which ever ratio elected of surround sound. Diagram 3 is a representation of how WiFi direct or Bluetooth connectivity would be implemented (with suitable speakers).

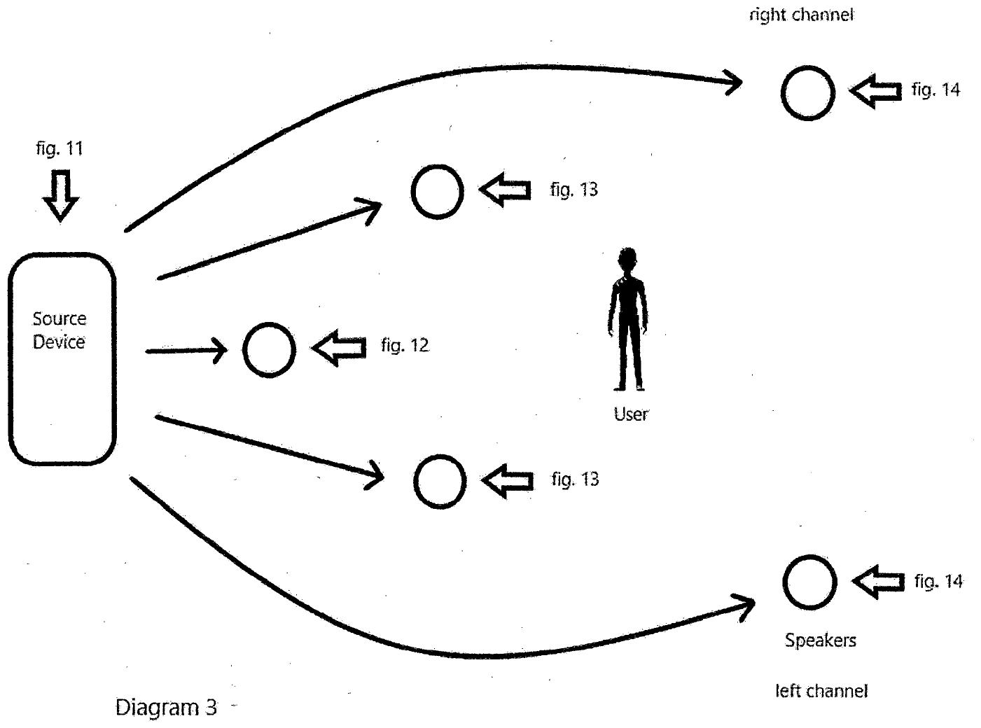

FIG. 11. As indicated in Diagram 3 is the source device suck as a smart phone, computer, laptop, tablet, game console, smart TV or any technical device that can support application software. The source device is the CPU and computing interface that the Socket Camera APP has been downloaded to. The APP on the source device will configure and pair the speakers and compute the surround sound ratio selected by the user and send the signals directly to the speakers via WiFi direct or Bluetooth transmissions. Diagram 3 is representative of 5.1 surround sound.

FIG. 12. As indicated in diagram 3 is a centre (front) speaker.

FIG. 13. As indicated in diagram 3 are front speakers. One left channel and one right channel.

FIG. 14. As indicated in diagram 3 are rear speakers. One left channel and one right channel.

1. I claim That the Socket Camera APP is the software application that will be used to communicate and provide data and unique binary instructions to the Socket Camera hardware device.
It will manifest coded data that will stitch the images it captures to be rendered for viewing in virtual reality in a VR headset or on a monitor device in VR.
This APP will configure coded data that will enable a VR headset to send direct code to the Socket Camera to manoeuvre (pan or tilt) according to the directions that the user is turning their head while donning the VR headset.
The sensors in the VR headset that create the virtual reality effect can detect when the user turns their head left, right, up or down and will relay the coding data to the Socket camera to perform the functions of panning and tilting in real time.
The Socket Camera APP will facilitate the pairing of a camera namely the Socket Camera to a VR headset and VR Controller system so while utilizing a hand held device, joystick or remote control device one will be capable of controlling the Socket Camera to perform functions like pan, tilt, zoom and make selections that are available in the menu of the Socket Camera while wearing a VR headset to be viewed in VR in real time in the VR headset.
This APP will be capable of a 360 degree pan and tilt VR capture ‘stitching’ and rendering.
This APP will configure multiple Socket Camera(s) that are registered and paired locally or installed at remote locations on a remote Wi-fi network(s) that the user is currently not attending and the user will be able to access and control the cameras with a VR headset system by means of internet and Wi-fi transmissions provided by your ISP.

2. I claim that the Socket Camera APP will also enable light bulb speakers, mini speakers or any Wi-fi or Bluetooth speakers namely that of the Socket Camera to pair and assign each unit containing speakers as surround sound speakers for your smart TV(s), smart phones, game console, computer, laptop, tablet or personal device.
Each unit containing speakers could be assigned as left, right, centre, middle, front or rear speakers allowing the user to achieve 2.1, 4.1, 5.1, 7.1 or which ever ratio elected of surround sound
The Socket Camera APP stated in claims 1 and 2 will have wireless connectivity to perform its functions and this will be executed by the Socket Camera APP by means of UHF, RF, Wi-fi (network), Wi-fi direct or Bluetooth connections.
